(19) United States
(12) Patent Application Publication
(10) Pub. No.: US 2012/0146951 A1
(43) Pub. Date: Jun. 14, 2012

(54) TOUCH DETECTING SYSTEM

(75) Inventors: KUAN-HONG HSIEH, Tu-Cheng (TW); HAN-CHE WANG, Tu-Cheng (TW); RUEY-SHYANG YOU, Tu-Cheng (TW); BIN-GANG DUAN, Shenzhen City (CN); GANG LI, Shenzhen City (CN)

(73) Assignees: HON HAI PRECISION INDUSTRY CO., LTD., Tu-Cheng (TW); HONG FU JIN PRECISION INDUSTRY (ShenZHEN) CO., LTD., Shenzhen City (CN)

(21) Appl. No.: 13/154,452

(22) Filed: Jun. 7, 2011

(30) Foreign Application Priority Data
Dec. 14, 2010 (CN) 201010587321.8

(51) Int. Cl. G06F 3/042

(52) U.S. Cl. 345/175

(57) ABSTRACT

A touch detecting system for installation on a touch panel includes two point light sources arranged along one side of a touch panel, an optical sensor disposed at an opposite second side of the touch panel, at least one optical lens, and a processing unit. The at least on optical lens is disposed between the second side of the touch panel and the optical sensor. The at least one optical lens is spaced from the touch panel and the optical sensor, for directing the light from the point light sources to the optical sensor. The optical sensor captures an image which including two dark points of the light from the point light sources when a touch object is on the touch panel. The processing unit determines the position of the touch object on the touch panel based on positions of the dark points in the image.

### BACKGROUND

1. Technical Field

The present disclosure relates to touch technology, and particularly, to a touch detecting system.

2. Description of the Related Art

A conventional touch detecting system includes a number of optical elements, such as a CCD (Charge Coupled Device, CCD) and/or optical lenses which are arranged in a relatively complex structure in a touch panel or a touch pad. The complex structure of conventional touch detecting systems involves a high cost.

Therefore, there is room for improvement within the art.

### BRIEF DESCRIPTION OF THE DRAWINGS

The components in the drawings are not necessarily drawn to scale, the emphasis instead being placed upon clearly illustrating the principles of a touch detecting system. Moreover, in the drawings, like reference numerals designate corresponding parts throughout the several views.

FIG. 1 is a schematic view of a touch detecting system in accordance with an exemplary embodiment.

FIG. 2 is a schematic view showing light from the touch detecting system of FIG. 1 which is blocked by an object.

FIG. 3 is a schematic view showing how to determine the point of contact of the touch detecting system of FIG. 1.

FIG. 4 is a schematic view of a touch panel using the touch detecting system of FIG. 1 in accordance with an exemplary embodiment.

### DETAILED DESCRIPTION

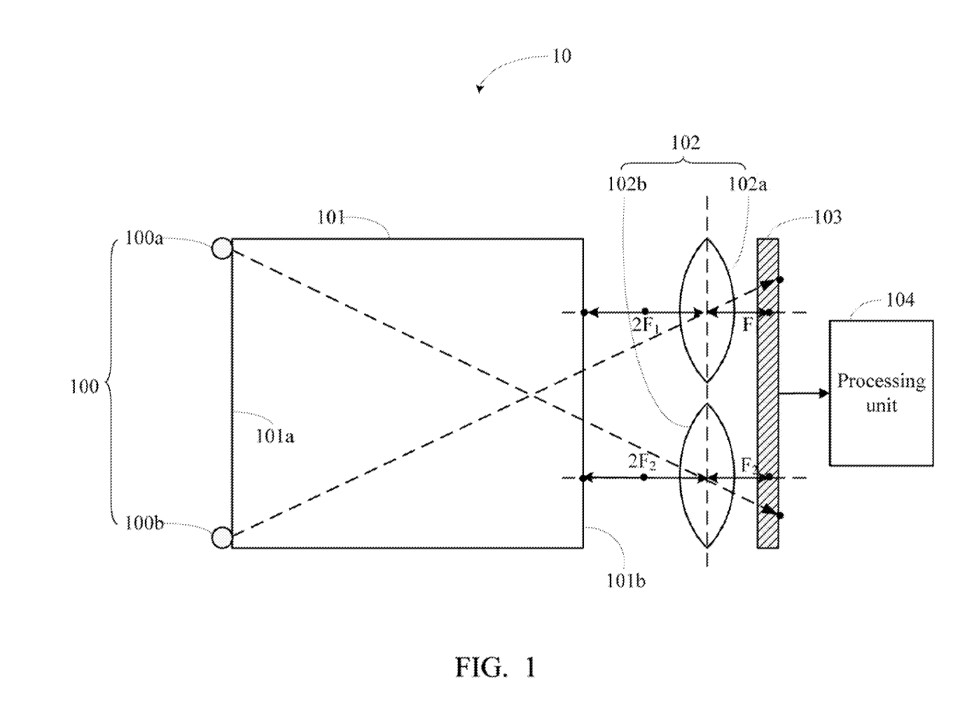

Referring to FIG. 1, an embodiment of a touch detecting system 10 applied to a touch panel 101 is shown. The system 10 is employed to determine which point on the touch panel 101 is touched. The system 10 includes a number of point light sources 100, at least one optical lens 102, and an optical sensor 103. The point light sources 100 are arranged along the left side 101a of the touch panel 101. The point light sources 100 emit light across the touch panel 101 to the right side 101b of the touch panel 101. In one embodiment, there are two point light sources 100a and 100b arranged along the left side 101a of the touch panel 101. The point light source 100a is above the point light source 100b. The point light sources 100a and 100b may be light emitting diodes (LEDs), or infrared transmitters.

The at least one optical lens 102 is disposed at the right side of the touch panel 101 and opposite to the point light sources 100a and 100b. The distance between the optical lens 102 and the right side 101b is substantially twice the focal length of the optical lens 102. The at least one optical lens 102 directs the light from the point light sources 100a and 100b to the optical sensor 103. In this embodiment, there are two optical lenses 102a and 102b, which are arranged in a column along the right side 101b. The optical lens 102a is above the optical lens 102b. The focal lengths of the optical lenses 102a and 102b are the same. The optical lenses 102a and 102b are both converging.

The optical sensor 103 is disposed to the right of the optical lens 102, and is separated from the optical lens 102 by a distance equal to the focal length of the optical lens 102. The optical sensor 103 captures an image of the light from the point light sources 100a and 100b. In this embodiment, the optical sensor 103 is a linear CCD. In an alternative embodiment, the optical sensor 103 may be a linear Complementary Metal-Oxide-Semiconductor Transistor (CMOS), or another optical position-sensing detector.

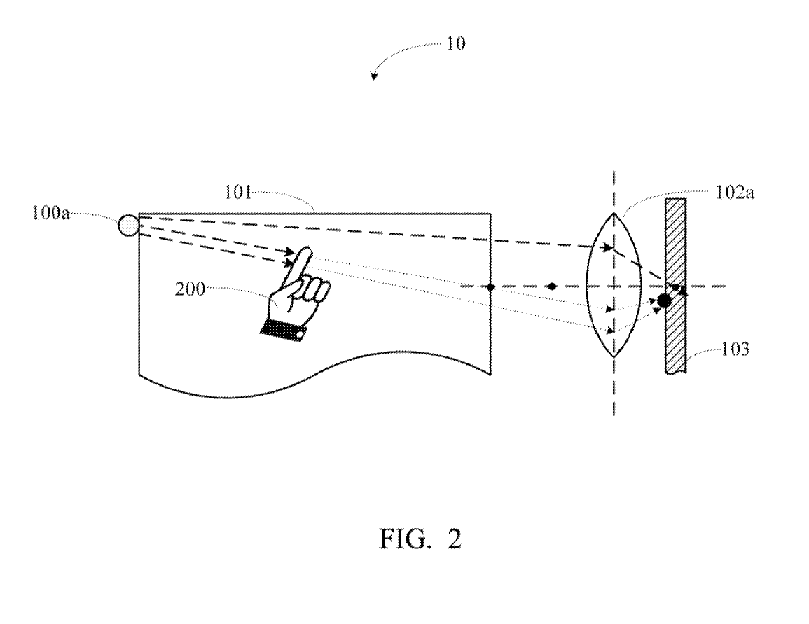

FIG. 2 is a schematic view showing the light from the point light source 100a being blocked by an object 200. In detail, the optical lens 102a guides the light from the point light source 100a to the optical sensor 103. When the touch panel 101 is touched by the object 200, a portion of the light from the point light source 100a is blocked by the object 200 and cannot reach the optical sensor 103, thus the optical sensor 103 receives an image which includes a dark point.

The touch detecting system 10 further includes a processing unit 104 (see FIG. 1), for determining which point on the touch panel 101 is being touched according to the images received by the optical sensor 103. In this embodiment, the processing unit 104 employs a trilateration method to determine which point is being touched.

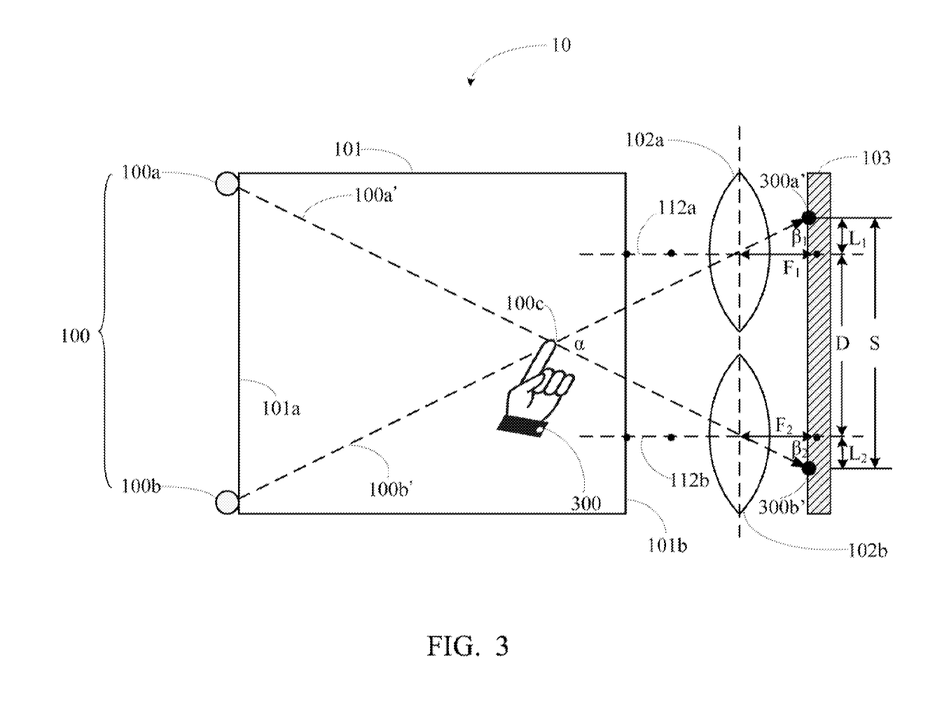

FIG. 3 is employed to illustrate how the processing unit 104 determines which point is being touched using the trilateration method. When the light 100a′ and 100b′ from the point light sources 100a and 100b respectively are blocked by the object 300, the optical sensor 103 receives an image including two dark points 300a′ and 300b′. The processing unit 104 determines the distance “S” between the dark points 300a′ and 300b′ according to the coordinates of the points 300a′ and 300b′.

The axes (optical axis 112a and optical axis 112b) of the optical lenses 102a and 102b are parallel. The distance between the optical axis 112a and the dark point 300a′ is L₁, and the distance between the optical axis 112b and the dark point 300b′ is L₂. In this embodiment, L₁ is equal to L₂. The distance “D” between the optical axes 112a and 112b is predetermined and stored in the system 10. The processing unit 104 determines L₁ and L₂ according to a formula Ln=(S-D)/2 where n=1 or 2. F₁ and F₂ are the respective focal lengths of the optical lenses 102a and 102b. In this embodiment, F₁ is equal to F₂. Angle α is created between the lightbeams 100a′ and 100b′. The lightbeam 100b′ meets the optical sensor 103 at an angle of β₁, and the lightbeam 100a′ meets the optical sensor 103 at an angle of β₂. The processing unit 104 determines the angles α and βₙ according to the following equations where n=1 or 2:

βₙ=arctan(Fₙ/Lₙ) (Equation 1);

α=180°-β₁-β₂ (Equation 2);

As the lightbeam 100a′ meets the lightbeam 100b′ at a point of 100c, with the dark points 300a′ and 300b′ form a triangle, thus the processing unit 104 is capable of determining the coordinates of the point of contact made by the object 300 according to the angles α, β₁, β₂, and the distance “S” and “D” using a trilateration method.

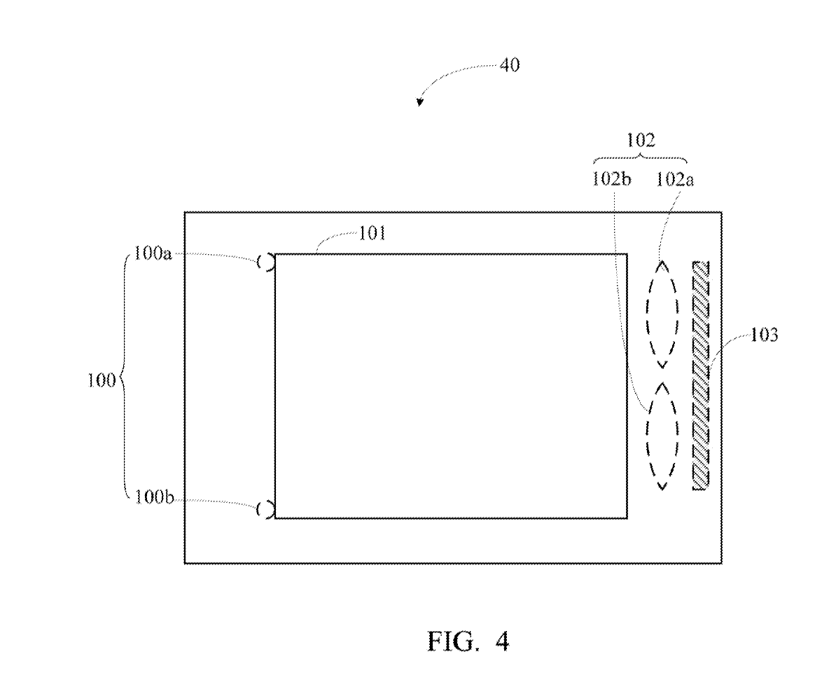

FIG. 4 shows the system 10 applied to a display apparatus 40. The display apparatus 40 includes the touch panel 101. In this embodiment, the point light sources 100 are disposed in the left hand side of the frame of the display apparatus 40, and the optical lenses 102 and the optical sensor 103 are disposed in the right hand side of the frame of the display apparatus 40. In an alternative embodiment, the point light sources 100 may be at the right side of the touch panel 101, and the lenses 102 and the sensor 103 may be at the left side of the touch panel 101.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A touch detecting system for installation on a touch panel, the touch detecting system comprising:
two point light sources configured for being arranged along a first side of a touch panel;
an optical sensor configured for being disposed at an opposite second side of the touch panel;
at least one optical lens configured for being disposed between the second side of the touch panel and the optical sensor, the at least one optical lens being spaced from the touch panel and the optical sensor, the at least one optical lens configured for directing the light from the point light sources to the optical sensor, the optical sensor configured for capturing an image of the light from the point light sources when a touch object is on the touch panel, the image comprising two dark points caused by the touch object; and
a processing unit configured for determining the position of the touch object on the touch panel based on positions of the dark points in the image.

2. The touch detecting system as recited in claim 1, wherein the at least one optical lens is spaced a first distance from the touch panel, and the first distance is twice a focus length of the at least one optical lens.

3. The touch detecting system as recited in claim 1, wherein the at least one optical lens is spaced a second distance from the optical sensor, and the second distance is equal to a focus length of the at least one optical lens.

4. The touch detecting system as recited in claim 1, wherein the at least one optical lens comprises two optical lens arranged along the second side of the touch panel and the focus lengths of the two optical lens are the same.

5. The touch detecting system as recited in claim 4, wherein the two optical lenses are converging lenses.

6. The touch detecting system as recited in claim 1, wherein the point light sources are light-emitting diodes.

7. The touch detecting system as recited in claim 1, wherein the point light sources are infrared point light sources.

8. The touch detecting system as recited in claim 1, wherein the optical sensor is a linear charge coupled device.

9. The touch detecting system as recited in claim 1, wherein the optical sensor is a linear complementary metal-oxide-semiconductor transistor.
